(19) United States
(12) Patent Application Publication
(10) Pub. No.: US 2026/0360206 A1
(43) Pub. Date: Nov. 12, 2026

(54) HOST SYSTEM INSTALLATION OF MECHANICAL REEL GAMES

(71) Applicant: IGT, Las Vegas, NV (US)

(72) Inventors: Dwayne Nelson, Las Vegas, NV (US); Kevin Higgins, Reno, NV (US)

(21) Appl. No.: 19/200,067

(22) Filed: May 6, 2025

(51) Int. Cl. G07F 17/32; G07F 17/34

(52) U.S. Cl. CPC G07F 17/3213; G07F 17/34

(57) ABSTRACT

The present disclosure relates generally to gaming systems, servers, and methods. As an example, a method is disclosed that includes receiving a trigger event associated with a gaming device, the gaming device comprising a preprinted surface viewable by a player, responsive to the trigger event, receiving an identifier associated with the preprinted surface and a game type executable by the gaming device; validating that the received identifier of the preprinted surface corresponds to the game type; in response to successfully validating that the received identifier corresponds to the game type, enabling, by the processor, the gaming device to execute the game type; and in response to unsuccessfully validating that the received identifier corresponds to the game type, disabling, by the processor, the gaming device from executing the game type.

### BACKGROUND

The present disclosure is generally directed to gaming systems and, in particular, toward features providing updates within gaming systems.

Current electronic gaming machines require periodic updates to existing games or installation of new games. While such updates and game installations are software-only changes that can be done readily through the gaming network, some electronic gaming machines require manual changes in addition to software changes.

### BRIEF SUMMARY

In certain embodiments, the present disclosure relates to a system, a server, and a method. In some embodiments, a gaming device is provided that comprises a first rotatably mounted reel containing a first preprinted reel strip comprising a first plurality of game symbols, the first rotatably mounted reel corresponding to a first game type; a motor rotatably coupled to the first rotatably mounted reel; a communications interface; a processor coupled with the communications interface; and a memory coupled with and readable by the processor and storing therein a set of instructions. The instructions when executed by the processor, causes the processor to: responsive to a play command, receive a randomly selected game result and generate stepper pulses to cause the motor to position the first rotatably mounted reel in accordance with the randomly selected game result; determine that the first preprinted reel strip has been replaced by a second preprinted reel strip comprising a different second plurality of game symbols; provide, via the communication interface, an identifier of the second preprinted reel strip to a gaming server; and responsive to a successful validation that the identifier corresponds to a second game type different from the first game type, update, by the processor, the memory with a second set of instructions configured to play the second game type.

In some embodiments, a server is provided, comprising: a communications interface; a processor coupled with the communications interface; and a memory coupled with and readable by the processor and storing therein a set of instructions which, when executed by the processor, causes the processor to: receive a trigger event associated with a gaming device, the gaming device comprising a rotatable wheel comprising a preprinted surface viewable by a player, responsive to the trigger event, receive an identifier associated with the preprinted surface and a game type executable by the gaming device; validate that the received identifier of the preprinted surface corresponds to the game type; in response to successfully validating that the received identifier corresponds to the game type, enable the gaming device to execute the game type; and in response to unsuccessfully validating that the received identifier corresponds to the game type, disable the gaming device from executing the game type.

In some embodiments, a method is provided that comprises: receiving, by a processor, a trigger event associated with a gaming device, the gaming device comprising a preprinted surface viewable by a player, responsive to the trigger event, receiving, by the processor, an identifier associated with the preprinted surface and a game type executable by the gaming device; validating, by the processor, that the received identifier of the preprinted surface corresponds to the game type; in response to successfully validating that the received identifier corresponds to the game type, enabling, by the processor, the gaming device to execute the game type; and in response to unsuccessfully validating that the received identifier corresponds to the game type, disabling, by the processor, the gaming device from executing the game type.

Additional features and advantages are described herein and will be apparent from the following Description and the figures.

### BRIEF DESCRIPTION OF THE SEVERAL VIEWS OF THE DRAWINGS

FIG. 1 is a block diagram of a system including a gaming server in accordance with embodiments of the present disclosure;

FIG. 2 is a block diagram depicting details of a gaming device in accordance with embodiments of the present disclosure;

FIG. 3 is a block diagram depicting details of a gaming server in accordance with embodiments of the present disclosure;

FIG. 4 is an isometric view of reel assemblies of a gaming device in accordance with embodiments of the present disclosure;

FIG. 5 is an isometric view of reel assemblies of a gaming device in accordance with embodiments of the present disclosure;

FIG. 6 is an isometric view of a reel assembly of a gaming device in accordance with embodiments of the present disclosure;

FIG. 7 is an isometric view of multiple of the reel assemblies of FIG. 6;

FIG. 8 is a front view of a gaming device in accordance with embodiments of the present disclosure;

FIG. 9 is a front view of a gaming device in accordance with embodiments of the present disclosure;

FIG. 10 is a diagram of a user interface in accordance with embodiments of the present disclosure;

FIG. 11 is a diagram of a reel validation method in accordance with embodiments of the present disclosure;

FIG. 12 is a signal flow diagram in accordance with embodiments of the present disclosure;

FIG. 13 is a signal flow diagram in accordance with embodiments of the present disclosure;

FIG. 14 is a signal flow diagram in accordance with embodiments of the present disclosure;

FIG. 15 is a signal flow diagram in accordance with embodiments of the present disclosure;

FIG. 16 is a signal flow diagram in accordance with embodiments of the present disclosure;

FIG. 17 is a flow diagram depicting a method of validating reel strips in accordance with embodiments of the present disclosure; and

FIG. 18 is a flow diagram depicting a method of updating a game configuration to provide gaming features to gaming devices in accordance with embodiments of the present disclosure.

### DETAILED DESCRIPTION

Embodiments of the present disclosure will be described in connection with an Electronic Gaming Machine (EGM), mobile device, and/or gaming device that are configured to interact with a gaming system. While particular embodiments will be described in connection with the gaming system having a distributed architecture, it should be appreciated that certain behaviors or features of a gaming device may be carried out with other architectures. For instance, aspects of the present disclosure contemplate that a gaming system may execute various methods and features described herein in a mainframe or centralized game management system. Indeed, the various features described in connection with an EGM, mobile device, and/or gaming device are not limited to use in a distributed gaming system but can be applied to any number of system architectures without departing from the scope of the present disclosure.

Embodiments of the disclosure describe signal flows between a gaming device and host gaming server to substantially synchronize the configuration of gaming device updates and other changes, such as changing pre-printed reel strips (e.g., that do not comprise refreshable flexible displays such as organic light emitting diodes or OLEDs or electronic paper type flexible displays), wheel covers, signage, and other content on reel stepper and wheel games. While the gaming software can be updated or changed remotely by the gaming server, the pre-printed content must be changed manually by the operator. If the gaming software were to be updated without changing the pre-preprinted content, the gaming device may produce unintended game outcomes that are not only unexpected by the player but also violate prevailing laws and regulations. Even if the gaming device produced the intended game outcome, the pre-printed content may be incompatible with the sound and video effects of the new game, such as the content and new game being directed to different game themes. This signal flow can reduce the amount of time the gaming device is out of service and substantially minimize the occurrences of misconfiguration of the gaming device, such as from accidentally installing the wrong reel strip on the gaming device.

In some embodiments, the gaming system receives a trigger event associated with a gaming device having a preprinted surface viewable by a player, responsive to the trigger event, receives an identifier associated with the preprinted surface and a game type executable by the gaming device; validates that the received identifier of the preprinted surface corresponds to the game type; in response to successfully validating that the received identifier corresponds to the game type, enables the gaming device to execute the game type; and in response to unsuccessfully validating that the received identifier corresponds to the game type, disables the gaming device from executing the game type.

The game type refers to a set of game settings and parameters that produce different game outcomes or player experiences. For example, the game type can be determined by one or more of the following features: game theme (e.g., themes and brands from different TV shows, movies, brands, sport, fruit, adventure and exploration, ancient civilizations, fantasy and magic, animals and nature, etc.), game symbol types (e.g., low-paying, medium-paying, and high-paying symbols such as cherries, bars, bells, sevens, and fruits), special symbols (e.g., wild symbols, scatter symbols, bonus symbols, and multiplier symbols), and numbers employed, jackpot type (e.g., flat top or progressive), bonus round availability, return to player (RTP) and volatility as defined by the pay table, and other parameters.

By way of illustration, the gaming device can be a slot machine that includes a first rotatably mounted (typically analog) reel containing a first preprinted reel strip comprising a first plurality of game symbols corresponding to a first game type and a motor rotatably coupled to the first rotatably mounted reel. Responsive to a play command, the gaming device processor receives a randomly selected game result and generates stepper pulses to cause the motor to position the first rotatably mounted reel in accordance with the randomly selected game result. In response to the first preprinted reel strip being replaced by a second preprinted reel strip comprising a different second plurality of game symbols for a different second game type, the gaming device provides as reel validation information an identifier of the second preprinted reel strip to the gaming server. Responsive to a successful validation that the reel strip validation information corresponds to the second game type different from the first game type, the gaming device updates its memory with a second set of instructions configured to play the second game type.

In some applications, reel validation further requires confirmation that a state of the gaming machine is idle for at least a predetermined period of time before validation is performed. If the gaming machine is not idle for the predetermined period of time, validation cannot be successfully performed.

The first and second preprinted reel strips can have the same or a different number or type of symbols printed on a plastic strip, depending on the first and second game types.

The preprinted reel strips can be formed from any flexible material that can be removed and replaced on the reels, such as paper, plastic or vinyl, and the like that can withstand the wear and tear of repeated use while ensuring that the symbols remain vibrant and legible. The symbols and designs on the reel strips are typically printed using high-quality, durable inks that resist fading and smudging. In some configurations, one or more of the reel strips are transmissive reels in which a transparent video overlay is positioned on top of the pre-printed reel strips. The player can view the pre-printed symbols on the strip while the transparent video overlay can provide animation, multiplier s and other special features.

The reel validation information can include a reel strip identifier, reel position identifier, and selected symbol location on the reel. The reel strip identifier can be the same or different for the reel strips in the set of pre-printed for a common game type. In the latter case, the reel position identifier can be important to ensure that the correct reel strip is mounted on the proper reel. The selected symbol location on the reel (e.g., the “home” position for the reel strip) ensures that the plurality of symbols are correctly registered with the gaming system such that the random game output produces the desired or predetermined game outcome. A misregistered reel strip can yield, in response to the random game output, a different game outcome than the predetermined game outcome.

Reel validation information, such as reel strip identifier and associated reel position identifier, can be collected manually or automatically depending on the application. In the former case, an operator could acquire the reel validation information via a scanned, photographed, or otherwise captured image obtained by a mobile device, manual input into a user interface such as on a mobile device or the gaming device, or other technique and forwarded to the gaming server. In the latter case, one or more active and/or passive sensors can be used to wirelessly exchange or otherwise acquire the reel validation information for transmission to the gaming server. The sensor can be mounted, for example, on the corresponding reel, reel mounting plate, or reel control board and/or on the strip itself (e.g., as an RFID chip). The reel strip identifier and reel position identifier can be collected for example, by an RFID reader (when the identifier is stored in an RFID chip), optical reader (when the identifier is a QR or bar code), and other wireless sensing or acquisition techniques.

While the present disclosure is discussed with reference to a slot machine, it is to be appreciated that can be applied to other types of gaming devices having pre-printed content that must be changed when the game type to be executed by the machine changes. For example, the gaming device can be a wheel game or spin wheel gaming machine comprising a pre-printed reel wheel face. The preprinted surface is mounted on the wheel and is divided into various segments, each segment representing a different game outcome. The gaming device can include other types of surfaces comprising game type-specific pre-printed labels or other content, such as the transparent glass covering the gaming components (e.g., slot reels) or other portions of the EGM housing.

While the present disclosure contemplates a gaming device, such as an EGM or Video Lottery Terminal (VLT), in a gaming system, it is to be appreciated that the present disclosure can apply to an EGM and/or mobile device that is configured to operate as a thin client with one game instance served to the gaming device by a gaming server (e.g., a host server).

It is common for host servers in gaming systems to update or change remotely and automatically gaming software (such as changing the software package for a first type of game to a different and incompatible software package for a second type of game) on a gaming device followed by reconfiguring game settings and parameters, thereby reducing substantially the manual labor involved to effect the update. While this paradigm works for many gaming device types, certain types of gaming devices with pre-printed content, such as on a reel strip or wheel game cover, are not able to be updated or changed remotely without scheduling manual labor to change out the pre-printed content. However, such scheduling can cause unacceptable levels of gaming device downtime. If the gaming device is put too quickly back into service after the software change or the reel strips are incorrectly installed (e.g., in the wrong orientation or ordering or at a wrong home position), unpredictable game outcomes can result through the use of one or more incorrect reel strips, thereby causing player frustration and potentially violating prevailing gaming rules and regulations.

The technical solution can substantially optimize the workflow for changing pre-printed content and installing new game software packages by the host server, thereby substantially minimizing the amount of time the gaming device is out of service. This outcome can be achieved by automatically installing the game software when the pre-printed content is changed. The host server can take the gaming device out of service without a predetermined time of the scheduled content replacement and delay installing the new game package software until notice is received that the pre-printed content has been replaced and the identifiers associated with the newly installed pre-preprinted content have been successfully validated as corresponding to the new game. For example, in a slot machine the reel validation information can include a reel strip identifier and an associated reel strip position identifier for a slot machine having multiple reels. In this manner, the gaming device could be out of service for a very small window while the operator installs the new reel strips.

The technical solution can reduce or eliminate errors of incorrectly installing the right reel strips or installing the reel strips in the incorrect order. When a reel strip identifier cannot be sensed by the sensor, for instance, there is a substantially probability that the reel strip is incorrectly installed, such as upside down or in the wrong “home” position. The use of a reel location identifier with the reel strip identifier can ensure that the reel strips are installed in the proper sequence or order on the reels, particularly when the reel strips are different from each other such as having different collections or sets of symbols (e.g., different types or numbers of symbols) or use different symbols for the “home” position for the strip.

The technical solution can further provide higher levels of game security by preventing fraud by players accessing the interior of the gaming device and installing different reel strips, changing the sequence or order of the reel strips, or changing the home positions on one or more of the reel strips. This is effected by using, as a trigger event for reel strip validation, a sensed instance of access to the cabinet interior.

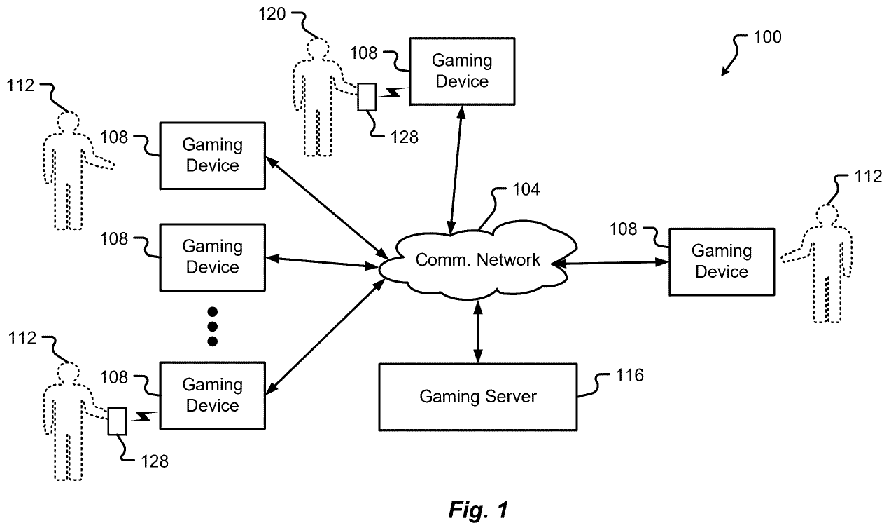

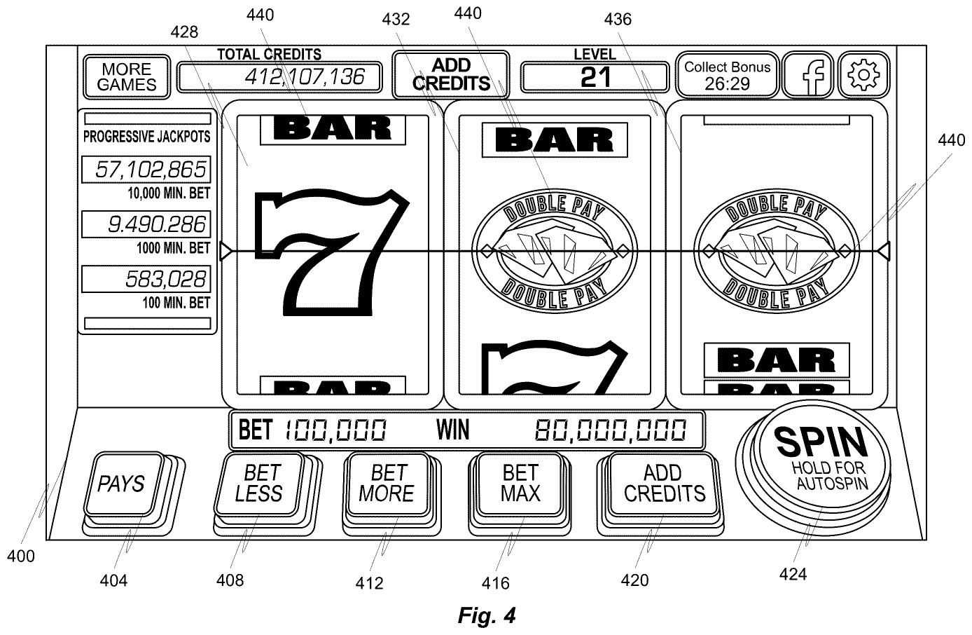

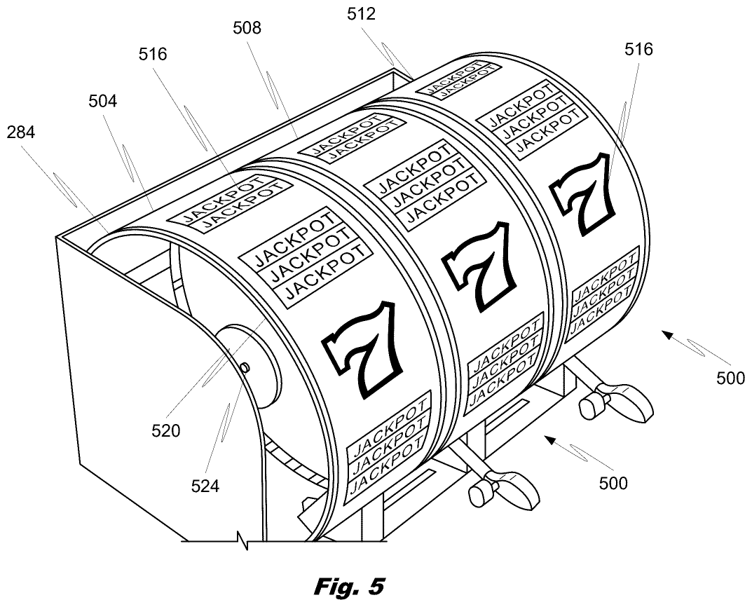

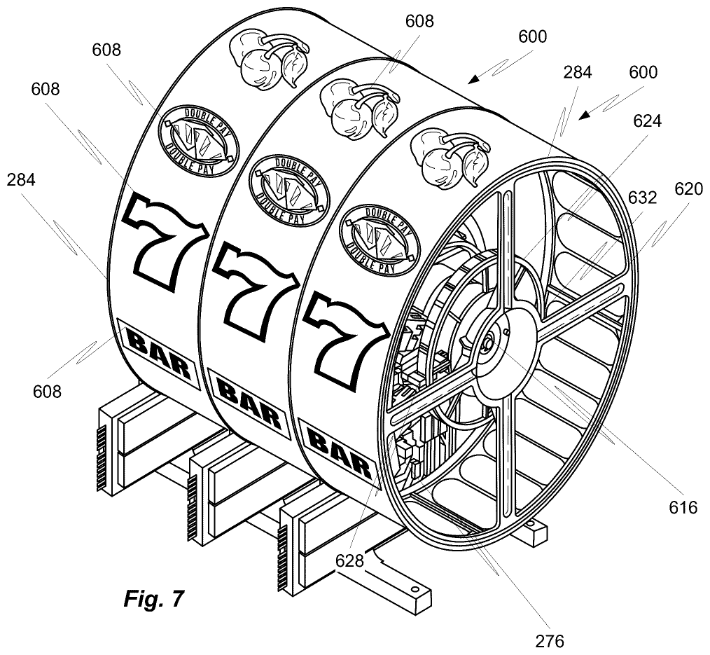

These and other aspects will now be described in further details with reference to FIGS. 1-18.

### Gaming System

With reference initially to FIG. 1, details of an illustrative gaming system 100 will be described in accordance with at least some embodiments of the present disclosure. The components of the system 100, while depicted as having particular instructions and devices, are not necessarily limited to the examples depicted herein. Rather, a system according to embodiments of the present disclosure may include one, some, or all of the components depicted in the system 100 and does not necessarily have to include all of the components in a single device.

The gaming system 100 is shown to include one or more communication networks 104 that interconnect and facilitate machine-to-machine communications between one or multiple gaming devices 108 and a gaming server 116. It should be appreciated that a communication network 104 may correspond to one or many communication networks or cellular networks without departing from the scope of the present disclosure. In some embodiments, the gaming devices 108 and gaming server 116 may be configured to communicate using various nodes or components of the communication network 104.

The communication network 104 may include wired and/or wireless communication technologies. The Internet is an example of the communication network 104 that constitutes an Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a cellular network, and any other type of packet-switched or circuit-switched network known in the art. In addition, it can be appreciated that the communication network 104 need not be limited to any one network type, and instead may be comprised of a number of different networks and/or network types. Moreover, the communication network 104 may comprise a number of different communication media such as coaxial cable, copper cable/wire, fiber-optic cable, antennas for transmitting/receiving wireless messages, and combinations thereof.

In some embodiments, the gaming devices 108 may be distributed throughout a single property or premises (e.g., a single casino floor) or the gaming devices 108 may be distributed among a plurality of different properties. In the depicted embodiment, three or more gaming devices 108 are depicted as being co-located in a common location (e.g., a first casino) whereas another gaming device 108 is depicted as being positioned in a location different from the other gaming devices 108. It should be appreciated that more than one gaming device 108 may be separated by other gaming devices 108 by one or multiple different communication networks 104.

Some or all of the gaming devices 108 in a common physical location (or within a wireless communication range of one another) may be connected with a cellular access point via a wireless connection. As some non-limiting examples, a cellular access point made available to a gaming device 108 may include a cellular base station, a Wi-Fi access point, a modem, a wireless router, or the like. The communication network 104 may utilize any type of multiplexing scheme to manage the various communications from multiple gaming devices 108. Examples of such multiplexing schemes include, without limitation, Frequency Division Multiple Access (FDMA), Time Division Multiple Access (TDMA), Code Division Multiple Access (CMDA), and/or Space Division Multiple Access (SDMA).

The various gaming devices 108 may utilize the same or different types of communication protocols to connect with the communication network 104. It should also be appreciated that the gaming devices 108 may or may not present the same type of game or wagering interface to a player 112. For instance, a first gaming device 108 may correspond to a gaming device that presents a slot game to the player 112, the second gaming device 108 may correspond to a sports betting terminal, and other gaming devices 108 may present lottery games or other types of games or a plurality of different games for selection and eventual play by a player 112.

A gaming device 108 may correspond to a type of device that enables player 112 interaction in connection with making wagers, communicating, watching live competitive contests, and/or playing games of chance. For instance, the gaming devices 108 may correspond to a type of device that enables a first player 112 to interact with a second player 112 at respective gaming devices 108. In other embodiments, each player 112 may be enabled to play a game individually at a gaming device 108.

As will be discussed in further detail herein, a player 112 or operator 120 may be allowed to carry a mobile device 128 and the mobile device 128 may also be used to interact with the game management system 116. A mobile device 128 and a gaming device 108 may each be considered a gaming device without departing from the scope of the present disclosure. A mobile device 128 may be utilized by the player 112 to create a player account, manage player profile information at the game management system 116, by the operator 120 to interact with the gaming device 108 as described herein in connection with updating or changing the game package software and/or pre-preprinted content on the gaming device 108 and/or otherwise connect with a gaming device 108. It should also be appreciated that a mobile device 128 may be provided with functionality similar or identical to a gaming device 108. In some embodiments, a mobile device 128 may be considered a particular type of gaming device in that a player 112 may utilize the mobile device 128 and resources thereof to play games of chance or other types of wagering games.

In some embodiments, a player 112 or operator 120 may login to the gaming system 100 by presenting the mobile device 128 to a gaming device 108, which causes components of the gaming device 108 to initiate a login process with the gaming system 100 on behalf of the player 112 or operator 120. Alternatively or additionally, a player 112 may anonymously engage in gameplay at a gaming device 108 and/or mobile device 128 without departing from the scope of the present disclosure. Still further in the alternative, the player 112 may present a loyalty card or other physical credential different from the mobile device 128 to log into the gaming system 100 and receive features based on the gaming system's 100 knowledge of the player's 112 gameplay preferences.

As mentioned above, the gaming system 100 may correspond to a system used by a casino operator to manage slot games, video poker games, bingo games, keno games, or the like that are played on one or more of the gaming devices 108 and/or mobile devices 128. In some embodiments, the gaming system 100 may correspond to a system used by the casino operator to manage slot games by players 112 at a gaming device 108. As another example, the gaming system 100 may be used by to manage and execute a lottery game or multiple lottery games. As will be discussed in further detail herein, the gaming system 100 may be configured to remotely update or change the game package software being executed on the gaming devices.

### Gaming Device

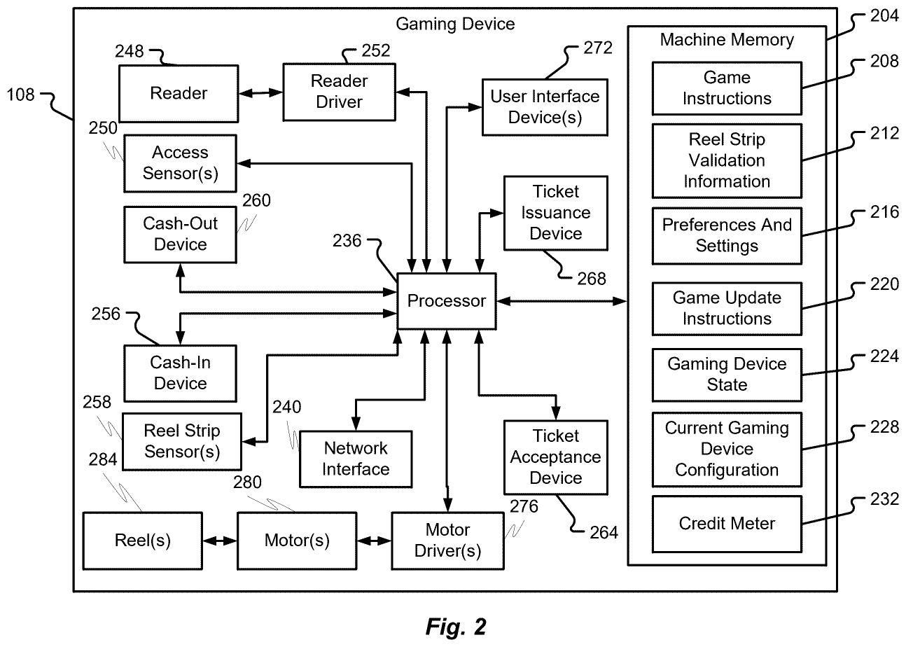

With reference now to FIG. 2, additional details of a gaming device 108 will be described in accordance with at least some embodiments of the present disclosure. It should be appreciated that some or all of the components of a single gaming device 108 may be distributed across multiple gaming devices 108 (of the same or different type) without departing from the scope of the present disclosure. It should also be appreciated that a gaming device 108 may correspond to a gaming device 108 and/or a mobile device 128 without departing from the scope of the present disclosure.

The gaming device 108 is shown to include machine memory 204, a processor 236, a network interface 240, a reader 248, a reader driver 252, access sensor(s) 250, a cash-in device 256, a cash-out device 260, reel strip sensor(s) 258, a ticket acceptance device 264, a ticket issuance device 268, motor driver(s) 276, motor(s) 280, reel(s) 284, and one or more user interface devices 272.

The processor 236 may include one or multiple computer processing devices. In some embodiments, the processor 236 may include a microprocessor, a CPU, a microcontroller, or the like. The processor 236 may also be configured to execute one or more instructions stored in machine memory 204.

The machine memory 204 may include one or multiple computer memory devices that are volatile or non-volatile. The machine memory 204 may be configured to store instructions that enable player 112 interaction with the gaming device 108, that enable the gaming device 108 to interact with a game of chance, that enable the gaming device 108 to interact with a gaming system 100, and that enable the player 112 to interact with the game gaming system 100. The machine memory 204 may be provided as a computer-readable medium that stores the instructions and various other data structures or code elements. Examples of instructions that may be stored in the machine memory 204 include game instructions 208 and game update instructions 220, and the like. The machine memory 204 is also shown to store various types of data or data sets describing the gaming device 108, including reel strip validation information 212 associated with reel strips currently installed on the gaming device 108, current gaming device state 224, current gaming device configuration 228 (including hardware/software version information), preferences and settings 216, and/or a credit meter 232.

The game instructions 208, when executed by the processor 236, may enable the gaming device 108 to facilitate one or more games of chance or skill and produce interactions between the player 112 and the game of chance or skill. In some embodiments, the game instructions 208 may include subroutines that present one or more graphics and/or audio content to the player 112 via a user interface device 272 in accordance with preferences and settings 216, subroutines that calculate whether a particular game wager has resulted in a win or loss during the game of chance or skill, subroutines for determining payouts for the player 112 in the event of a win, subroutines for determining whether a player 112 has enough available credits in the credit meter 232 to allow a particular bet or set of bets, and any other subroutine or set of instructions that facilitate gameplay at or in association with the gaming device 108. In some embodiments, activities, outputs, or inputs of the game instructions may be stored or recorded as machine state information, which may also be stored in machine memory 204. In some embodiments, the game instructions 208 may correspond to instructions that receive game content from the gaming system 100 and that render a display via the user interface device(s) 272 for the player 112 of the gaming device 108 based on the game content received from the game management system 116.

In some embodiments, the preferences and settings 216 may correspond to gameplay preferences or settings defined by the player 112 of the gaming device 108. The preferences and settings 216 may be specific to a particular gaming session or may be preserved for use across multiple gaming sessions. In some embodiments, the preferences and settings 216 may initially correspond to default preferences and settings 216 defined by the gaming device 108 but may be updated with the player's 112 preferences and settings 216, which may be different from the default preferences and settings 216.

The game instructions 208 may also be configured to report information from the credit meter 232. The credit meter 232 may correspond to a device or collection of devices that facilitates a tracking of wager activity or available wager credits at the gaming device 108. Such credits may be made available for wagers or bets placed on a game managed by the gaming system 100. In some embodiments, the credit meter 232 may be used to store or log information related to various player 112 activities and events that occur at the gaming device 108. The types of information that may be maintained in the credit meter 232 include, without limitation, player information, available credit information, RTP information, wager amount information, and other types of information that may or may not need to be recorded for purposes of accounting for wagers placed at the gaming device 108 and payouts made for a player 112 during a game of chance or skill played at the gaming device 108. In some embodiments, the credit meter 232 may be configured to track coin-in activity, coin-out activity, coin-drop activity, jackpot paid activity, bonus paid activity, credits applied activity, external bonus payout activity, ticket/voucher in activity, ticket/voucher out activity, timing of events that occur at the gaming device 108, and the like.

The game update instructions 220, when executed by the processor 236, may enable the gaming device 108, in response to signals, instructions, or commands received from the gaming server 116, to collect and provide reel strip validation information 212, current gaming device configuration 228 (e.g., information describing the current hardware and game package software version executing on the gaming device 108), and gaming device state 224 to the gaming server 116 in connection with reel strip validation to enable a software package update and to update aspects of the gaming device 108 in connection with the software package update. For instance, the game update instructions 220 may be configured to update game instructions 208 or game features provided by execution of the game instructions 208 in response to receiving an appropriate signal from the gaming server 116. Alternatively or additionally, the game update instructions 220 may update preferences and settings 216 or other components of the gaming device 108. Further still, the game update instructions 220 may be configured to update or add new games to the game instructions 208 in response to receiving an appropriate signal from the gaming server 116. Such updates may be performed based on the hardware/software version and other capabilities of the gaming device 108.The game update instructions 220, when executed by the processor 236, may also enable the gaming device 108 to sense an access instance to a defined area of the gaming device, such as the gaming device cabinet interior, and, responsive thereto, collect and provide reel strip validation information 212, current gaming device configuration 228, and gaming device state 224 to the gaming server 116 in connection with reel strip validation.

The network interface 240 may correspond to or include any type of device that enables the gaming device 108 to connect with the communication network 104 or with another gaming device 108. In some embodiments, the network interface 240 may include one or more communication ports, switches, routes, etc. that connect with a cable or the like. Alternatively or additionally, the network interface 240 may include an antenna and/or a driver for the antenna that enables the gaming device 108 to wirelessly communicate with other machines.

The cash-in device 256 may include a bill acceptor, a coin acceptor, a chip acceptor or reader, or the like. In some embodiments, the cash-in device 256 may also include credit card reader hardware and/or software. The cash-out device 260 may operate and issue cash, coins, tokens, or chips based on an amount indicated within the credit meter 232. In some embodiments, the cash-out device 260 may include a coin tray or the like and counting hardware configured to count and distribute an appropriate amount of coins or tokens based on a user's 112 winnings or available credit within the credit meter 232.

The gaming device 108 may also be provided with a ticket acceptance device 264 that is configured to accept or scan physically printed tickets/vouchers and extract appropriate information therefrom. In some embodiments, the ticket acceptance device 264 may include one or more machine vision devices (e.g., a camera, IR scanner, optical scanner, barcode scanner, etc.), a physical ticket acceptor, a shredder, etc. The ticket acceptance device 264 may be configured to accept physical tickets and/or electronic tickets without departing from the scope of the present disclosure. An electronic ticket/voucher may be accepted by scanning a one-dimensional barcode, two-dimensional barcode, or other type of barcode or quick response (QR) code displayed by a player's 112 mobile communication device 128, for example.

The ticket issuance device 268 may be configured to print or provide physical tickets/vouchers to users 112. In some embodiments, the ticket issuance device 268 may be configured to issue a ticket/voucher consistent with an amount of credit available to a player 112, possibly as indicated within the credit meter 232.

With reference to FIGS. 2, 4, and 9, the user interface device(s) 272 may correspond to any type of mechanical or software-based input and/or output device. In some embodiments, the user interface device(s) 272 may be provided on a common panel or portion 400, 900 of the gaming device 108 and may be used to initiate a predetermined function in response to being pressed by the player 112. In addition to the examples of user interface devices 272 described above, it should be appreciated that a user interface device 272 may alternatively or additionally take the form of one or more depressible buttons 404, 904, 408, 908, 412, 912, 416, 916, 420, 920, and 424, a lever 924 or “one armed bandit handle,” etc. The user interface device(s) 272 may include components that present content to the player 112 in a visual fashion (e.g., displays, lights, screens, etc.) or components that present content to the player 112, such as transparent glass panel 928 and reel strips 428, 432, and 436 in payline 440. The user interface device(s) 272 may include components that present content to the player 112 in an audible fashion (e.g., buzzers, speakers 244, headphones, etc.). The user interface device(s) 272 may also include one or more combined user input/user output devices (e.g., a touch-sensitive display or a lighted button) without departing from the scope of the present disclosure.

The reader 248 may be configured to read credentials of different types. For instance, the reader 248 may be configured to read the mobile device 124 or other credentials that operate with a defined protocol or utilize an expected data format. The format or form factor of a credential carried by the player 112 or operator 120 should not be limited to any particular type of format or form factor. Examples of suitable form factors that may be as a credential include, without limitation, magstripe cards, chip-based cards, contactless/wireless cards, key fobs, mobile devices 128, optically-readable cards, or the like. It should be appreciated that a player's 112 or operator's 120 credential may be capable of being read by a reader 248 when brought within a predetermined distance of the reader 248 (e.g., if the reader 248 includes an antenna and is utilize a contactless communication protocol like Near Field Communications (NFC) or Bluetooth). Alternatively or additionally, a credential may be capable of being read by a reader 248 when inserted to a slot of a card reader 248 or swiped through a card reader 248. To the extent that the form factor of a credential can vary and is not limited, it should be appreciated that the reader 248 may be provided with any number of hardware and/or software components to enable interactions with a credential. More specifically, each a reader 248 may include one or multiple readers, each of which may be provided with appropriate hardware and/or software components to enable the reader 248 to extract/read data that is stored on a credential and/or mobile device 124.

With reference to FIGS. 2 and 4-7, each reel assembly 500, 600 comprises motor, typically a stepper motor 280, the reel 284 mounting game symbol 440, 516, 608-containing pre-printed reel strip 604, and a reel driver 612. In each reel assembly, the motor driver(s) 276 drive the motor(s) 280, which in turn rotate the reels 284 to output a predetermined game outcome on the payline 440. The reel 284 is mounted to a rotatable shaft 616 of the motor 280. The motor driver 276 includes a printed circuit board proximate to the reel 284 and is coupled to motor to cause the motor shaft 616 to rotate the reel 284. Each reel assembly The reel 284 includes an exterior cylinder 620 and an interior encoder wheel 624. The symbol-bearing reel strip 428, 432, 436, 500, 504, 508, 604 is wrapped around and affixed to the exterior cylinder 520, 620.

The symbols on the reel strips are typically unique to each game type, and, for a common game type, the symbol collection on each reel assembly is typically different, thus requiring an operator 120 to replace or install the correct strips for each game. For example, first, second, and third reel strips having first, second, and third collections of symbols might be used on a first game type while fourth, fifth and sixth reel strips having fourth, fifth, and sixth collections of symbols might be used on a second game type. Even when the reel strips in a given game have the same collections of symbols, the game symbol at the home position for each reel strip is typically different.

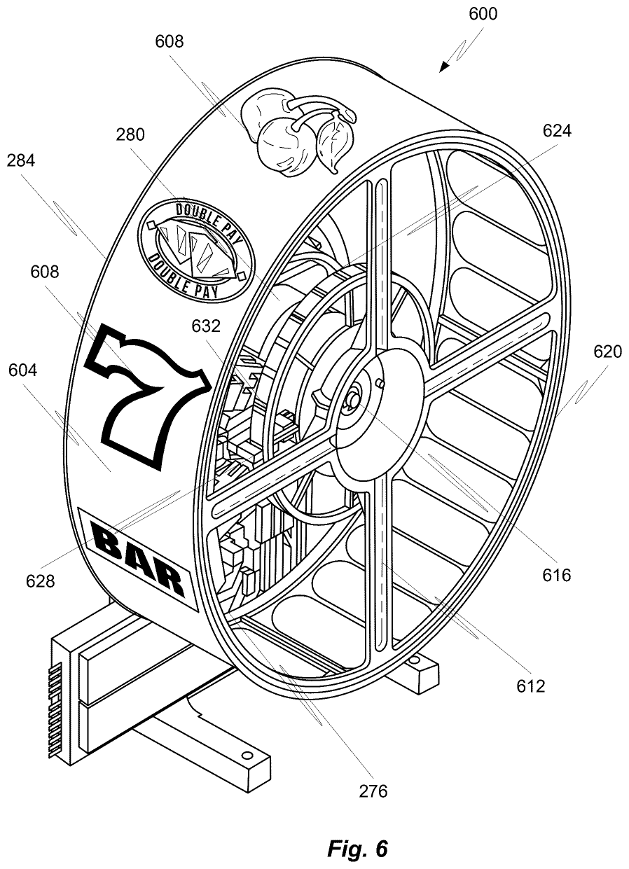

An optional encoder wheel 624 typically is a multi-tab notched disc mounted to either the motor shaft 524, 616 or to the exterior cylinder 620. The notched disc includes a plurality of equally spaced, identically shaped tabs (and subsequent notches) disposed along the disc's circumference. The tabs break an optical detector 628 of the reel driver 276 many times per revolution of the reel. One of the tabs that form the notches is uniquely patterned to define a single home position designated in FIG. 6 by the reference numeral 632. The remaining tabs are used to define the total number of symbol stops on the reel. As illustrated, the so-called “tabs” and “notches” may be defined by alternating opaque regions (tabs) and transparent regions (notches) of a cylindrical plastic member mounted to either the motor shaft 616 or to the exterior cylinder 620.

The drive motors 280 of the various reels 284 respond to applied signals from the associated motor drivers 276, which are progressively phase-shifted relative to each other such that the corresponding drive motor 280 is caused to turn one element of rotation for each progression of the phase signals. The motor driver generating the phase signals is typically a driver circuit, which responds to applied motor stepping pulses to advance each of the reels 284 in increments. The motor stepping pulses are generated by a processor (which may be same or different than the processor 236), a predetermined number of pulses being generated to cause each of the motors to be incremented to a selected respective stopping position to produce a predetermined game outcome. In practice, the stopping position is determined by either counting the number of motor pulses occurring after a “home” position marker on the reel 284 has passed a fixed sensor or by counting markers provided on the reel for each display position after the home position marker has passed.

The reel strip sensors 258 can include one or more different types of sensors.

A first type of reel strip sensor 258 senses automatically and wirelessly a reel strip identifier on each reel strip. Thus, each reel assembly typically comprises a separate reel strip sensor. In one configuration, the reel strip sensor 258 comprises an active or passive RFID reader to read an identifier from an RFID chip on the reverse side of the corresponding reel strip. In another configuration, the reel strip sensor 258 comprises an optical reader, such as optical reader 628, to read an identifier recorded in a QR or other type of bar code, one or more colors, or other type of image on the reverse side of the corresponding reel strip. FIG. 11 depicts the optical reader scanning the QR code 1100 to provide the reel strip identifier 1104 (shown as 1234). In another configuration, the reel strip sensor 258 comprises a Hall effect, magnetoresistive (MR), or other type of magnetic strip sensor to read an identifier recorded on a magnetic strip on the reverse side of the corresponding reel strip. In another configuration, shown in FIG. 12, the operator 120 uses a camera or mobile device 128 to take a picture of or scan the identifier of the reel strip and an indication of the corresponding reel assembly upon which the reel strip is mounted or of the installed reel strip when in the home position and uploads the image(s) to the gaming server 116. In the latter case, the gaming server 116 can determine the part number or identifier of the reel strip. In another configuration, the communication is not wireless but rather a physical connection (wired).

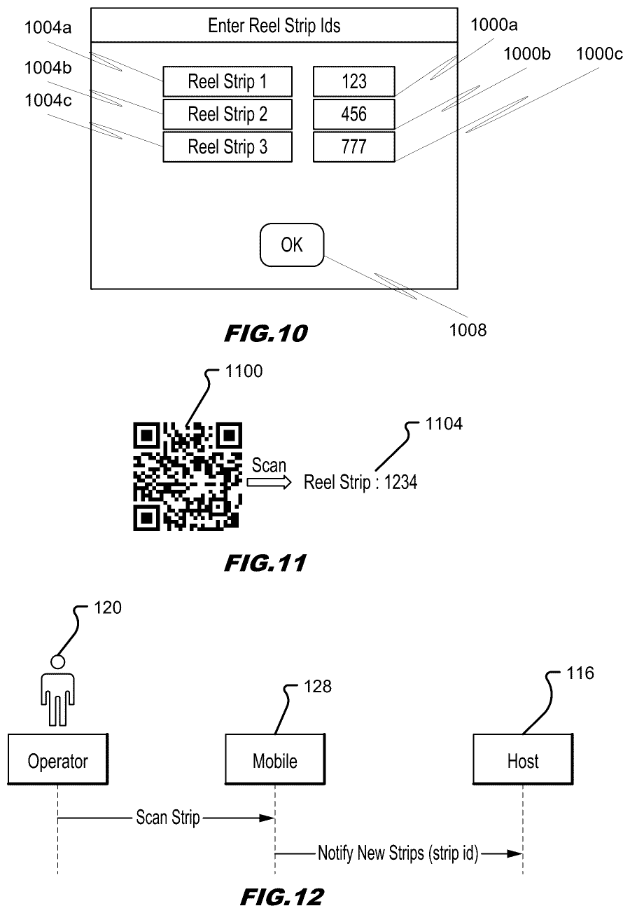

As noted above and as shown in FIG. 10, the operator 120, after being authenticated by the gaming system, can enter into the gaming device 108 itself the information shown in the display 1000. The information includes the reel strip identifier 1000 of each reel strip and the corresponding reel assembly position or identifier 1004 of the reel assembly on which the reel strip is mounted. For example, the first reel strip has a first reel strip identifier 1000a of “123” is mounted on the first reel assembly 1004a, the second reel strip has a second reel strip identifier 1000b of “456” is mounted on the second reel assembly 1004c, and the third reel strip has a third reel strip identifier 1000c of “777” is mounted on the third reel assembly 1004c. When the entered information is confirmed as being entered correctly, the operator can push the “OK” button 1008 and transmit the entered information to the gaming server 116. In an even simpler configuration, the operator 120 goes to the gaming device and notifies the gaming server that the reel strips are installed. This notification could simply be pushing a button indicating “I installed them”.

While the gaming device 108 is discussed with reference to three reel assemblies, it is to be understood that any number of reel assemblies may be used in the gaming device 108. It is further to be understood that the reel strips can contain any number of symbols (with 22 symbols/strip being typical) and, on a given gaming device, the reel strips may contain any number of symbols. The symbols are not limited to the game symbols noted above but can be images or blank (“ghost”) symbols where nothing is shown on the reel for that position.

A second type of reel strip sensor 258 senses automatically and wirelessly an orientation of the reel strip to determine whether or not the reel strip has been correctly installed on the reel. If the reel strip has been installed in an improper orientation, such as upside down or out of alignment with the home position marker, it can cause improper operation of the reel assembly and unexpected game results. This type of reel strip sensor can, for example, be any of the sensors above that senses the identifier only when the reel strip is correctly installed on the reel. In another configuration, the sensor can be a receiver that receives a wireless transmission from a transmitter that emits a signal only when the reel strip is correctly installed on the reel. The sensor can be a short-range wireless receiver, such as a Bluetooth™ low energy receiver that senses a signal emitted by a short-range transmitter positioned on the reel strip only when the reel strip is correctly installed on the reel. The sensor can be a photodiode that detects infrared light emitted by an infrared light emitting diode or LED positioned on the reel strip only when the reel strip is correctly installed on the reel. The second type of reel strip sensor could also be a mobile device 128, which can record a video of the various reel strips moving to selected positions. The video could be sent to the gaming server 116 to confirm that the video accurately records the symbols on each reel that should appear at the selected positions.

The access sensor 250 can be any passive or active or analog or digital sensor that senses an instance of human access to a defined area of the gaming device, such as an interior area of the gaming device (e.g., the interior of the cabinet 936 of the gaming device 108). The access sensor can be, for example, a motion sensor, magnetic contact sensor, infrared sensor, proximity sensor, photoelectric sensor, position sensor, touch sensor, and the like.

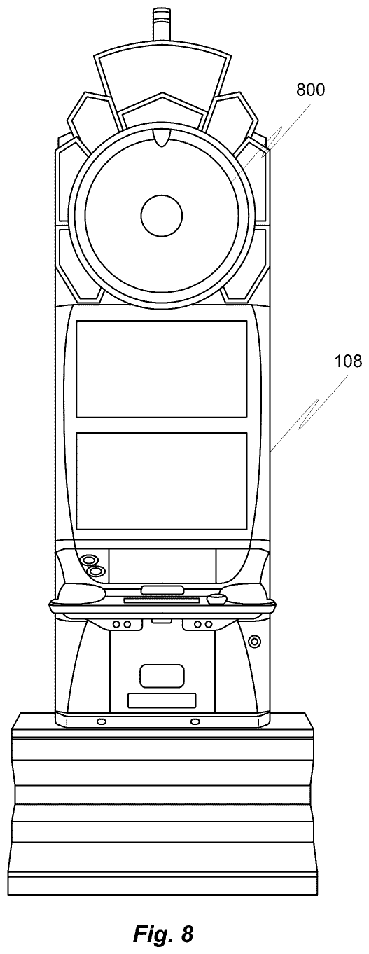

The gaming device 108 is not limited to slot machines. FIG. 8 depicts a gaming device that is configured to play a wheel game. The gaming device 108 includes a mechanical wheel topper 800. This mechanical wheel 800 works just like the mechanical reel assemblies described above. The operator 120 must install the correct mylar or plastic overlay onto the exterior surface of the wheel to match the software on the gaming device 108.

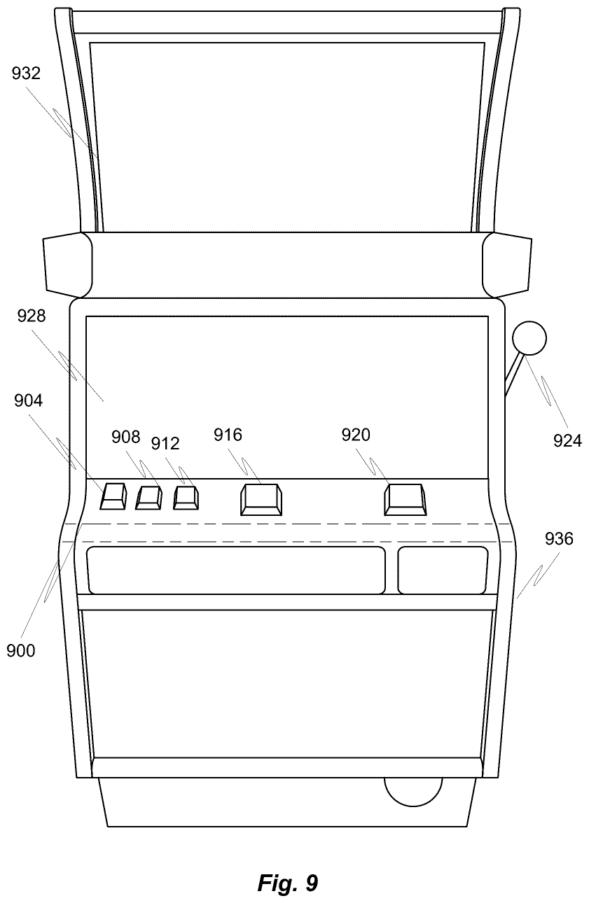

With reference to FIG. 9, the present disclosure is not limited to replacing a pre-printed reel strip or overlay but can apply to any removable pre-printed content on a gaming device that is game dependent. For example, the transparent surface 928 or topper surface can include pre-printed content that would require all or part of the surface to be removed and replaced when the software game package is changed.

### Game Management System

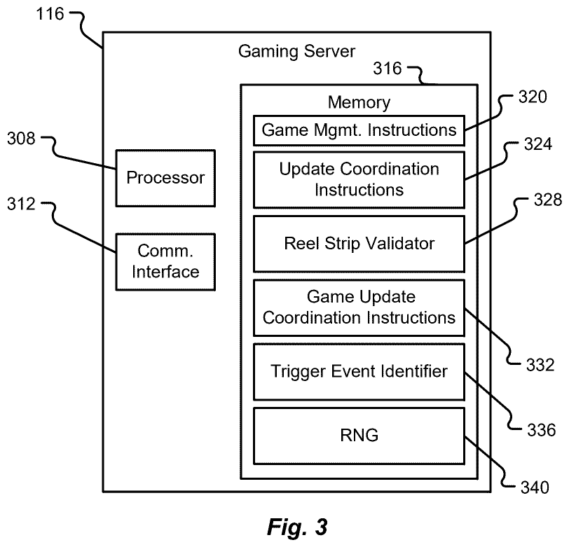

With reference now to FIG. 3, additional details of a gaming server 116 will be described in accordance with at least some embodiments of the present disclosure. The gaming server 116 can be a distributed computing architecture (e.g., a plurality of servers). Some or all of the plural servers in the gaming system 100 may be configured with similar components, instructions, code sets, or the like, which means that the gaming system 100 may correspond to a distributed and highly-available system in which one or more servers act to backup other servers. Alternatively or additionally, the servers of the gaming system 100 may be configured for parallel data processing capabilities. Although not depicted, one or more of the servers may be configured to execute a virtual machine or multiple virtual machines in connection with providing the gaming system 100.

Although details of a single server 116 are shown in FIG. 3, it should be appreciated that the other servers may be provided with similar or identical components. Alternatively, some components depicted in FIG. 3 may be provided in one server whereas other components may be provided in another server. For illustrative purposes, the gaming server 116 may include a processor 308, a communication interface 312, and memory 316.

The processor 308 may be similar or identical to processor 236. In some embodiments, the processor 308 may include one or multiple computer processing devices. In some embodiments, the processor 308 may include a microprocessor, a CPU, a microcontroller, or the like. The processor 308 may also be configured to execute one or more instructions stored in memory 316.

The communication interface 312 may enable the server 304 to connect with the wireless communication network 104 and/or communication network 124. The communication interface 312 may include one or more communication ports, switches, routes, etc. that connect with a cable or the like. Alternatively or additionally, the communication interface 312 may include an antenna and/or a driver for the antenna that enables the server 304 to wirelessly communicate with other machines.

The memory 316 may be similar or identical to other memory devices depicted and described herein. For instance, the memory 316 may be similar or identical to machine memory 204. The memory 316 may include one or more volatile or non-volatile memory devices that are configured to store instructions, programs, or other executables for execution by the processor 308. Alternatively or additionally, the memory 316 may be configured to store other data to be used in connection with providing game management functions for the gaming devices 108. The illustrative types of programs or executables that may be stored in memory 316 include, without limitation, game management instructions 320, update coordination instructions 324, reel strip validator 328, game update instructions 332, trigger event identifier 336 and a machine learning unit 328, and one or more neural networks 332. The memory 316 is also shown to include instructions for executing an RNG 340, though it should be appreciated that functionality of an RNG 340 may be provided by the processor 308 without executing instructions from memory. Rather, the RNG 340 may correspond to a particular routine that is natively built into the processor 308 and/or that relies on a clock of the processor 308 for generating a random or pseudo random output when called.

The game management instructions 320, when executed by the processor 308, may enable the server 304 to provide game management features and functions for some or all of the gaming devices 108, mobile devices 128, and/or gaming device 108. In some embodiments, the game management instructions 320 may be configured to interact with game instructions 208. More specifically, the game management instructions 320 may include subroutines that mirror subroutines in the game instructions 208. As another example, the game management instructions 320 may be configured to receive information reported by the gaming device 108 (e.g., outputs of the credit meter 232, outputs of the game instructions 208, activity updates, gaming device state information 224, player 112 information, etc.) and then produce further outputs for transmission back to the gaming device 108. The further outputs provided back to the gaming device 108 may be used as inputs for the game instructions 208 to continue executing a game of chance for a player 112.

In some embodiments, the game management instructions 320 may be responsible for enabling player 112 and operator 120 login activities, registering player profile information, and the like. In some embodiments, the game management instructions 320 may be configured to act as a proxy for some portions of code that would otherwise be provided in the game instructions 208. In such a configuration, the game management instructions 320 may provide a cloud-based or virtualized version of the game instructions 208 that are normally provided on a gaming device 108 itself. As an example, the game management instructions 320 may be configured to stream game content and game features to a gaming device 108, where the content and features are rendered for presentation to a player 112 of the gaming device 108.

The update coordination instructions 324, when executed by the processor 308, may enable the server 304 to coordinate reel strip replacement and software updates with the game update instructions 220 in the various gaming devices 108 in the gaming system 100. The software updates may include software game packages corresponding to different game types. For example, the software game packages can include parameters, settings, and instructions for one or more of the following features: game theme, game symbol types, special symbols, and numbers employed, jackpot type, bonus round type and availability, return to player (RTP) and volatility as defined by the pay table, and other parameters. Generally, the software game package for a first game type is incompatible with the software game package for a second game type, including incompatibility of the reel strips and/or specific ordering of the reel strips on the reel assemblies.

The reel strip validator 328, in response to a request by the update coordination instructions 324, receives the gaming device state 224, current gaming device configuration 228, and reel strip validation information 212 and validates that the currently installed reel strips and their installed reel assembly positions are correct for the currently installed software game package or software game package to be installed on a selected gaming device 108. In other words, for installation of a new software game package the reel strip validator validates that a selected gaming device 108 has been in an inactive game state for at least a predetermined period of time and that the reel strip identifiers and their installed reel assembly positions match those required or otherwise compatible with the software game package to be installed. For confirmation that a currently installed software game package matches the current hardware configuration of a selected gaming device 108, such as in response to a trigger event, the reel strip validator determines the current gaming device hardware and software configuration and validates that the currently installed reel strip identifiers and their installed reel assembly positions match those required or otherwise compatible with the currently installed software game package.

The trigger event identifier 336 receives an access sensor notification from a gaming device 108 that an instance of human access into a defined area has been detected. If the instance was not authorized, such as by successful authentication of an operator 120 at the gaming device 108, the trigger event identifier 336 invokes the reel strip validator 328 to confirm that the current hardware and software configurations of the gaming device 108 are compatible with each other, including validating that the current reel strip identifiers and their installed position on the reel assemblies (including not only validating that the reel strip is installed on the correct reel assembly but also that the correct reel strip symbol is installed at the home position) have not been changed.

### EXAMPLES

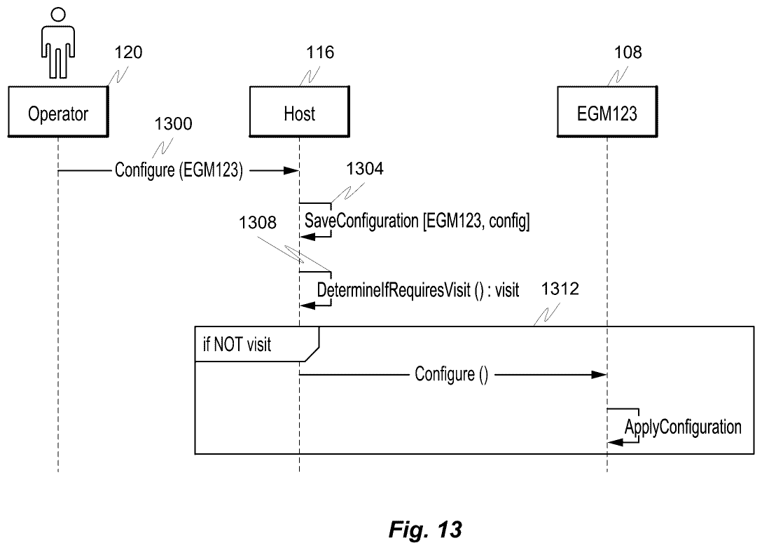

FIG. 13 depicts the signal flows resulting from the processor executing the update coordination instructions 324. The operator 120 interacts with the processor executing the game update instructions 332 and requests (operation 1300) (re)configuration of the gaming device 108 (assigned gaming device identifier 123) with a new software game package. In response, the host or gaming server 116 saves (operation 1304) the configuration instructions (e.g., the software game package) determines 1308 from the update coordination instructions 324 whether or not the configuration requires an on-site visit by the operator 120 to the gaming device 108 to change hardware, e.g., change reel strips or wheel overlay. If no on-site visit is required, the processor executing the update coordination instructions proceeds immediately with or schedules at a future time a software-only upgrade of the gaming device 108.

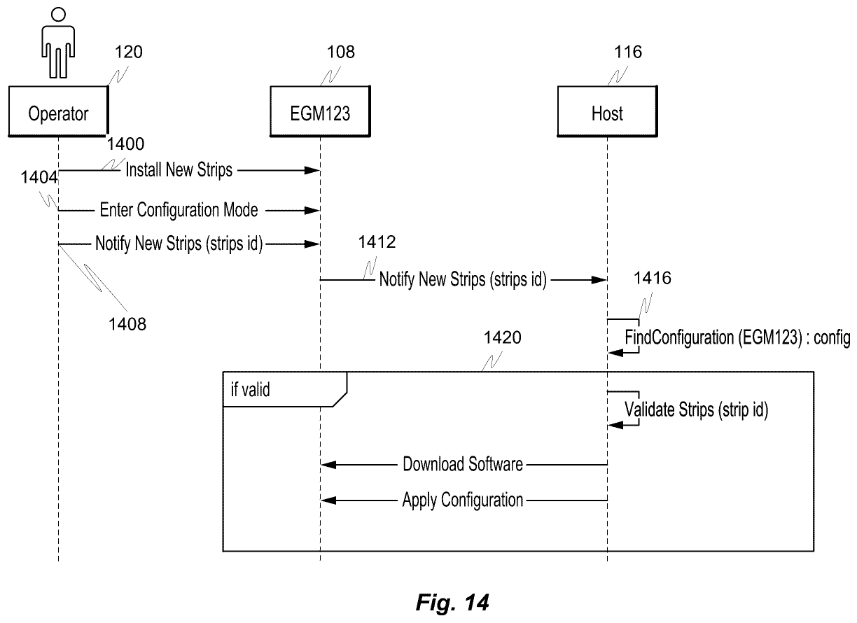

FIG. 14 depicts the operations resulting from the processor executing the update coordination and game update instructions when an on-site visit to the gaming device 108 (shown as a slot machine) is required to change out reel strips. The operator (or technician doing the installation work) installs (operation 1400) new reel strips on the gaming device, orders the gaming device 108 to enter the configuration mode (operation 1404), and notifies the gaming device of the reel strip validation information (e.g., the new reel strip identifiers and installation position on the reel assemblies). The gaming device, in response, generates a notification to the host 116 indicating that new reel strips are installed and providing the reel strip validation information (operation 1412). The host 116 finds the new configuration instructions (operation 1416) and in operation 1420 validates that the installed reel strips are correct or compatible with the new configuration instructions and, in response, downloads and/or configures the EGM accordingly (operation 1420). As will be appreciated, the host 116 can have a database (not shown) of reel strip identifiers and associated reel strips to use for each game, game package, paytable, or configuration. The Host 116 can then query to learn which reel strips go with which game types when deciding or validating the reel strips.

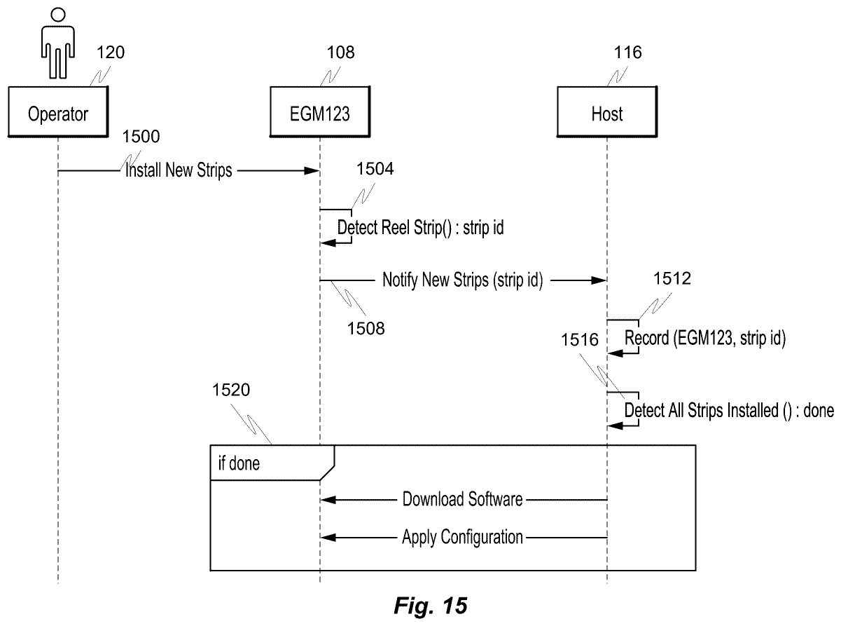

FIG. 15 depicts the operations resulting from the processor executing the update coordination and game update instructions when the gaming device automatically detects that the reel strip was changed by the operator 120 (operation 1500). Such automatic detection can result from the reel strip sensor(s) 258 detecting one or more reel strip identifiers different from the previously saved identifiers. In response, the gaming device saves the detected reel strip identifiers as the new or current reel strip identifiers and corresponding reel assembly positions (operation 1504) and generates a notification to the host, which includes the reel strip validation information (operation 1508). When the host 116 validates that all reel strip identifiers and associated reel assembly positions are correct (operation 1516), the host 116 downloads and configures the gaming device with the new software game package (operation 1520). This configuration can reduce errors since the operator is not required to indicate that the reel strips have changed.

While the above-described flows are serialized or synchronous in that the operator first installs the reel strips and then the host downloads the software in response, it is to be understood that the present disclosure can envision a more efficient flow in which the host downloads and configures the gaming device software while the operator changes the reel strips.

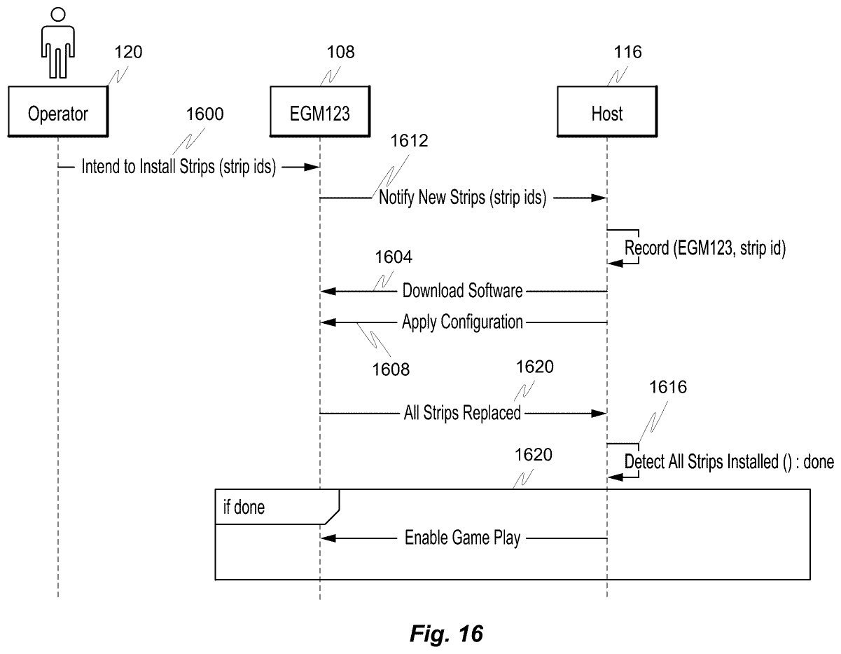

Referring now to FIG. 16, the operator 120 indicates to the gaming device that he or she intends to install one or more new reel strips now (operation 1600). The host 116 disables game play (not shown) and downloads software (operation 1604) and applies configuration changes (operation 1608) to the gaming device 108 while the operator is installing the new reel strips. The gaming device provides the reel strip validation information to the host (operation 1612). When the provided reel strip validation information is validated successfully as being compatible with the new game type (operation 1616) and the gaming device indicates all reel strips have been replaced (operation 1620), the host allows the new game type to be played on the gaming device (e.g., enables the cabinet or the game theme) (operation 1624).

As will be appreciated, the above operations can be performed in any order or sequence depending on the application.

While the disclosure is described in association with pre-printed content on the gaming device, it is to be understood that the teachings of this disclosure can be used with other hardware changes. For example, the gaming server might need to install a new software package that requires a new bill validator. The operator could install the new bill validator and in response to the new bill validator being installed and the identifier (e.g., serial number) of the bill validator being validated as failing within a range of serial numbers associated with the software package, the gaming server would install the new software.

### Methods

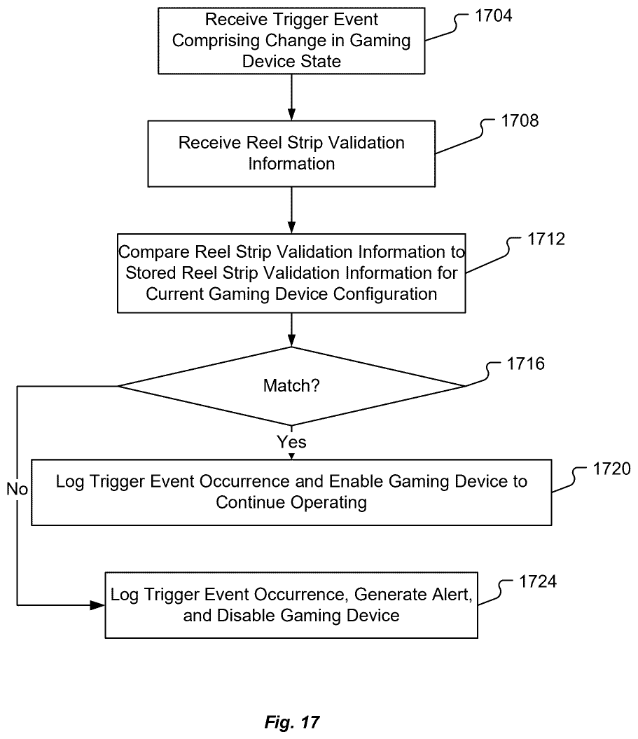

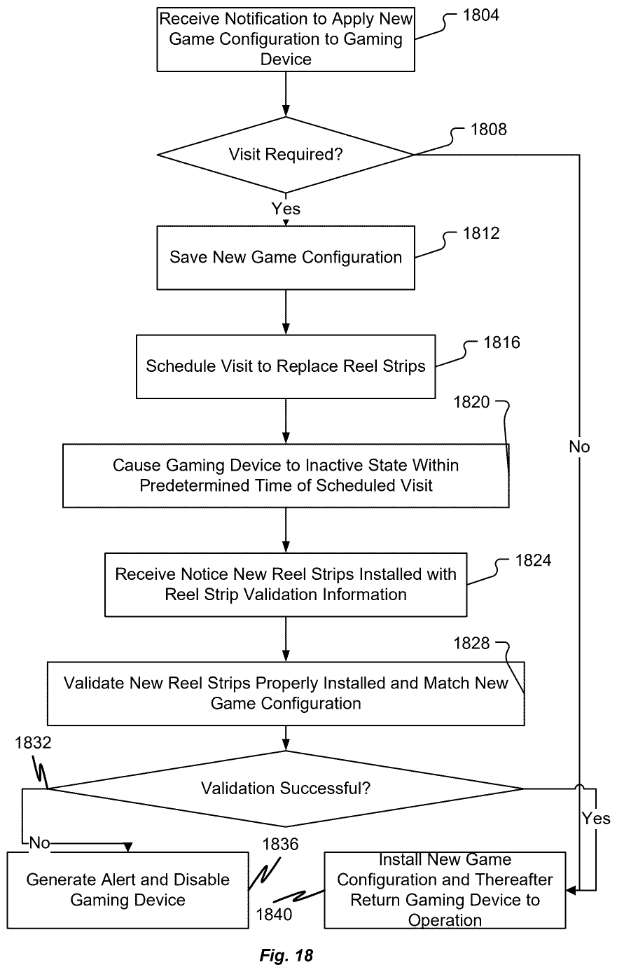

With reference now to FIGS. 17-18, various methods will be described in accordance with at least some embodiments of the present disclosure. It should be appreciated that the disclosed methods may be performed by one, some, or all of the devices depicted and described herein. Said another way, any device within the gaming system 100 may be used to perform some or all of a method depicted and described herein. Moreover, although certain steps are depicted as being performed in a certain order or in connection with a particular method, it should be appreciated that any method step depicted and described herein may be performed in combination with any other method step depicted and described herein.

Referring initially to FIG. 17, a method of validating gaming device configuration in response to a sensed trigger event will be described in accordance with embodiments of the present disclosure.

The method begins by the gaming server receiving from the gaming device a trigger event notification comprising a change in gaming device state. The gaming device state can be a sensed change in one or more reel strip identifiers or reel assembly position of a reel strip identifier and a sensed instance of human access to a defined area of the gaming device 108, for instance. (step 1704). The method continues by the gaming server 116 receiving currently sensed reel strip validation information (step 1708). The gaming server 116 compares the currently sensed reel strip validation information to stored reel strip validation information for the current gaming device configuration (step 1712) and determines whether they match or are compatible (decision diamond 1716). When the received reel strip validation information matches the saved current gaming device configuration, the gaming server 116 logs the occurrence and associated timestamp of the trigger event and enables the gaming device to continue gameplay operation (step 1720). When the received reel strip validation information fails to match the saved current gaming device configuration, the gaming server 116 logs the occurrence and associated timestamp of the trigger event and disables the gaming device from further gameplay operation (step 1724).

Referring now to FIG. 18, a method of validating gaming device configuration in response to a scheduled change of reel strips and software game package on a gaming device will be described in accordance with embodiments of the present disclosure.

The method begins when the gaming server 116 receives a notification to apply a new game configuration (e.g., new software game package) to the gaming device (step 1804). The gaming server 116 determines whether an on-site visit to the gaming device to change out reel strips or a wheel overlay is required (decision diamond 1808). In some applications, the same reel strips mounted on the reel assemblies in the same order or sequence can be used for different types of games. When an on-site visit is required, the gaming server 116 saves the new game configuration (step 1812) and schedules a visit to replace the reel strips, wheel overlay, or other pre-printed content (step 1816). The method continues with the gaming server 116 causing the gaming device state to change to an inactive state within a predetermined time of the scheduled visit (step 1820). The gaming server 116 receives a notification that the new reel strips are installed with the reel strip validation information (step 1828). The gaming server 116 compares the reel strip validation information with the reel strip identifiers and associated reel assembly positions for the new game type associated with the saved configuration and determines whether they match (decision diamond 1832). When they do not match, the gaming server 116 generates an alert to the operator and disables the gaming device (step 1836). When they do match or when no on site visit is required, the gaming server 116 installs the new game configuration and thereafter returns the gaming device to gameplay operation with the new game type enabled for play (step 1840).

### Variants

The present disclosure contemplates a variety of different gaming systems and environments each having one or more of a plurality of different features, attributes, or characteristics. A “gaming system” or “gaming environment” as used herein refers to various configurations of: (a) one or more central servers, central controllers, or remote hosts; (b) one or more electronic gaming devices such as those located on a casino floor; and/or (c) one or more gaming devices, such as desktop computers, laptop computers, tablet computers or computing devices, personal digital assistants, mobile phones, and other mobile computing devices. Moreover, an EGM as used herein refers to any suitable electronic gaming device which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure includes: (a) one or more electronic gaming devices in combination with one or more central servers, central controllers, or remote hosts; (b) one or more gaming devices in combination with one or more central servers, central controllers, or remote hosts; (c) one or more gaming devices in combination with one or more electronic gaming devices; (d) one or more gaming devices, one or more electronic gaming devices, and one or more central servers, central controllers, or remote hosts in combination with one another; (e) a single electronic gaming device; (f) a plurality of electronic gaming devices in combination with one another; (g) a single gaming device; (h) a plurality of gaming devices in combination with one another; (i) a single central server, central controller, or remote host; and/or (j) a plurality of central servers, central controllers, or remote hosts in combination with one another.

For brevity and clarity and unless specifically stated otherwise, “EGM” as used herein represents one EGM or a plurality of EGMs, “gaming device” as used herein represents one gaming device or a plurality of gaming devices and, in some embodiments, may include an EGM or multiple EGMs. The use of “server, central server, central controller, or remote host” as used herein represents one central server, central controller, or remote host or a plurality of central servers, central controllers, or remote hosts.

As noted above, in various embodiments, the gaming system includes an EGM in combination with a central server, central controller, or remote host. In such embodiments, the EGM is configured to communicate with the central server, central controller, or remote host through a data network or remote communication link. In certain such embodiments, the EGM is configured to communicate with another EGM through the same data network or remote communication link or through a different data network or remote communication link. For example, the gaming system includes a plurality of EGMs that are each configured to communicate with a central server, central controller, or remote host through a data network.

In certain embodiments in which the gaming system includes an EGM in combination with a central server, central controller, or remote host, the central server, central controller, or remote host is any suitable computing device (such as a server) that includes at least one processor and at least one memory device or data storage device. As further described herein, the EGM includes at least one EGM processor configured to transmit and receive data or signals representing events, messages, commands, or any other suitable information between the EGM and the central server, central controller, or remote host. The at least one processor of that EGM is configured to execute the events, messages, or commands represented by such data or signals in conjunction with the operation of the EGM. Moreover, the at least one processor of the central server, central controller, or remote host is configured to transmit and receive data or signals representing events, messages, commands, or any other suitable information between the central server, central controller, or remote host and the EGM. The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM. Further, one, more than one, or each of the functions of the at least one processor of the EGM may be performed by the at least one processor of the central server, central controller, or remote host.

In certain such embodiments, computerized instructions for controlling any games (such as any primary or base games and/or any secondary or bonus games) displayed by the EGM are executed by the central server, central controller, or remote host. In such “thin client” embodiments, the central server, central controller, or remote host remotely controls any games (or other suitable interfaces) displayed by the EGM, and the EGM is utilized to display such games (or suitable interfaces) and to receive one or more inputs or commands. In other such embodiments, computerized instructions for controlling any games displayed by the EGM are communicated from the central server, central controller, or remote host to the EGM and are stored in at least one memory device of the EGM. In such “thick client” embodiments, the at least one processor of the EGM executes the computerized instructions to control any games (or other suitable interfaces) displayed by the EGM.

In various embodiments in which the gaming system includes a plurality of EGMs, one or more of the EGMs are thin client EGMs and one or more of the EGMs are thick client EGMs. In other embodiments in which the gaming system includes one or more EGMs, certain functions of one or more of the EGMs are implemented in a thin client environment, and certain other functions of one or more of the EGMs are implemented in a thick client environment. In one such embodiment in which the gaming system includes an EGM and a central server, central controller, or remote host, computerized instructions for controlling any primary or base games displayed by the EGM are communicated from the central server, central controller, or remote host to the EGM in a thick client configuration, and computerized instructions for controlling any secondary or bonus games or other functions displayed by the EGM are executed by the central server, central controller, or remote host in a thin client configuration.

In certain embodiments in which the gaming system includes: (a) an EGM configured to communicate with a central server, central controller, or remote host through a data network; and/or (b) a plurality of EGMs configured to communicate with one another through a communication network, the communication network may include a local area network (LAN) in which the EGMs are located substantially proximate to one another and/or the central server, central controller, or remote host. In one example, the EGMs and the central server, central controller, or remote host are located in a gaming establishment or a portion of a gaming establishment.

In other embodiments in which the gaming system includes: (a) an EGM configured to communicate with a central server, central controller, or remote host through a data network; and/or (b) a plurality of EGMs configured to communicate with one another through a communication network, the communication network may include a wide area network (WAN) in which one or more of the EGMs are not necessarily located substantially proximate to another one of the EGMs and/or the central server, central controller, or remote host. For example, one or more of the EGMs are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs are located. In certain embodiments in which the communication network includes a WAN, the gaming system includes a central server, central controller, or remote host and an EGM each located in a different gaming establishment in a same geographic area, such as a same city or a same state. Gaming systems in which the communication network includes a WAN are substantially identical to gaming systems in which the communication network includes a LAN, though the quantity of EGMs in such gaming systems may vary relative to one another.

In further embodiments in which the gaming system includes: (a) an EGM configured to communicate with a central server, central controller, or remote host through a data network; and/or (b) a plurality of EGMs configured to communicate with one another through a communication network, the communication network may include an internet (such as the Internet) or an intranet. In certain such embodiments, an Internet browser of the EGM is usable to access an Internet game page from any location where an Internet connection is available. In one such embodiment, after the EGM accesses the Internet game page, the central server, central controller, or remote host identifies a player before enabling that player to place any wagers on any plays of any wagering games. In one example, the central server, central controller, or remote host identifies the player by requiring a player account of the player to be logged into via an input of a unique player name and password combination assigned to the player. The central server, central controller, or remote host may, however, identify the player in any other suitable manner, such as by validating a player tracking identification number associated with the player; by reading a player tracking card or other smart card inserted into a card reader; by validating a unique player identification number associated with the player by the central server, central controller, or remote host; or by identifying the EGM, such as by identifying the MAC address or the IP address of the Internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the Internet browser of the EGM. Examples of implementations of Internet-based gaming are further described in U.S. Pat. No. 8,764,566, entitled “Internet Remote Game Server,” and U.S. Pat. No. 8,147,334, entitled “Universal Game Server.”

The central server, central controller, or remote host and the EGM are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A gaming device, comprising:
a first rotatably mounted reel containing a first preprinted reel strip comprising a first plurality of game symbols, the first rotatably mounted reel corresponding to a first game type;
a motor rotatably coupled to the first rotatably mounted reel;
a communications interface;
a processor coupled with the communications interface; and
a memory coupled with and readable by the processor and storing therein a set of instructions which, when executed by the processor, causes the processor to:
responsive to a play command, receive a randomly selected game result and generate stepper pulses to cause the motor to position the first rotatably mounted reel in accordance with the randomly selected game result;
determine that the first preprinted reel strip has been replaced by a second preprinted reel strip comprising a different second plurality of game symbols;
provide, via the communication interface, an identifier of the second preprinted reel strip to a gaming server; and
responsive to a successful validation that the identifier corresponds to a second game type different from the first game type, update, by the processor, the memory with a second set of instructions configured to play the second game type.

2. The gaming device of claim 1, wherein the first and second preprinted reel strips comprises the first and second plurality of symbols printed on a plastic strip, wherein the first and second game types have a differing number or type of game symbols on the first and second preprinted reel strips, and wherein the processor causes application of a motor drive circuit responsive to the stepper pulses to applying phase signals to stator windings of the motor to cause the motor to incrementally rotate with each stepper pulse.

3. The gaming device of claim 1, further comprising a sensor, in communication with the processor, to sense wirelessly the identifier and transmit the wirelessly sensed identifier to the processor.

4. The gaming device of claim 3, wherein the sensor is mounted on the first rotatably mounted reel, a mounting plate, or a control board and wherein the identifier is stored in a radio-frequency identification (RFID) chip and the sensor comprises an RFID reader.

5. The gaming device of claim 1, further comprising a second rotatably mounted reel containing a third preprinted reel strip comprising a third plurality of game symbols different from the first and second plurality of game symbols, wherein the processor is configured to:
determine that the third preprinted reel strip has been replaced by a fourth preprinted reel strip comprising a different fourth plurality of game symbols;
provide, via the communication interface, a second identifier of the fourth preprinted reel strip to the gaming server; and
provide a reel strip position each of the second and fourth preprinted reel strips to the gaming server, wherein responsive to a successful validation that the second identifier corresponds to the second game type different from the first game type and respective reel strip positions of the second and fourth preprinted reel strips correspond to the second game type, update, by the processor, the memory with the second set of instructions configured to play the second game type.

6. The gaming device of claim 3, wherein the sensor is mounted on the first rotatably mounted reel, a mounting plate, or a control board and wherein the identifier is a bar code or QR code and the sensor comprises an optical reader.

7. A method, comprising:
receiving, by a processor, a trigger event associated with a gaming device, the gaming device comprising a preprinted surface viewable by a player,
responsive to the trigger event, receiving, by the processor, an identifier associated with the preprinted surface and a game type executable by the gaming device;
validating, by the processor, that the received identifier of the preprinted surface corresponds to the game type;
in response to successfully validating that the received identifier corresponds to the game type, enabling, by the processor, the gaming device to execute the game type; and
in response to unsuccessfully validating that the received identifier corresponds to the game type, disabling, by the processor, the gaming device from executing the game type.

8. The method of claim 7, wherein the gaming device is currently executing the game type and wherein the trigger event comprises sensing that an interior of the gaming device has been accessed.

9. The method of claim 7, wherein the gaming device is not currently executing the game type, wherein the trigger event comprises the received identifier being different from a stored identifier of the preprinted surface, the stored identifier corresponding to a second game type different from the game type corresponding to the received identifier, wherein the processor successfully validates that the received identifier corresponds to the game type, and wherein the enabling comprises causing the gaming device to install instructions to execute the game type associated with the received identifier.

10. The method of claim 9, wherein the gaming device comprises a rotatable wheel comprising the preprinted surface, wherein the rotatable wheel comprises a reel, wherein the preprinted surface comprises a reel strip mounted on the reel, wherein the game type associated with the received identifier corresponds to a first slot game type and the game type associated with the stored identifier corresponds to a different second slot game type.

11. The method of claim 10, further comprising receiving, by the processor, a second identifier associated with a second preprinted surface comprising a second plurality of game symbols and the game type executable by the gaming device, each of the first and second preprinted surfaces corresponding to different reel strip identifiers, and successfully validating, by the processor, that the different reel strip identifiers correspond to the game type.

12. The method of claim 9, wherein the gaming device comprises a rotatable wheel comprising the preprinted surface, wherein the preprinted surface is mounted on a wheel and is divided into various segments, each segment representing a different outcome, wherein the game type associated with the received identifier corresponds to a first wheel game type and the game type associated with the stored identifier corresponds to a different second wheel game type.

13. The method of claim 9, wherein the enabling is performed after the processor has confirmed that a state of the gaming device is idle for at least a predetermined period of time and that a selected game symbol of a plurality of game symbols on the pre-printed surface is located in a predetermined position on the rotatable wheel.

14. A system comprising:
a communications interface;
a processor coupled with the communications interface; and
a memory coupled with and readable by the processor and storing therein a set of instructions which, when executed by the processor, causes the processor to:
receive a trigger event associated with a gaming device, the gaming device comprising a rotatable wheel comprising a preprinted surface viewable by a player,
responsive to the trigger event, receive an identifier associated with the preprinted surface and a game type executable by the gaming device;
validate that the received identifier of the preprinted surface corresponds to the game type;
in response to successfully validating that the received identifier corresponds to the game type, enable the gaming device to execute the game type; and
in response to unsuccessfully validating that the received identifier corresponds to the game type, disable the gaming device from executing the game type.

15. The system of claim 14, wherein the gaming device is currently executing the game type and wherein the trigger event comprises sensing that an interior of the gaming device has been accessed.

16. The system of claim 14, wherein the gaming device is not currently executing the game type, wherein the trigger event comprises the received identifier being different from a stored identifier of the preprinted surface, the stored identifier corresponding to a second game type different from the game type corresponding to the received identifier, wherein the processor successfully validates that the received identifier corresponds to the game type, and wherein the enabling comprises causing the gaming device to install instructions to execute the game type associated with the received identifier.

17. The system of claim 16, wherein the rotatable wheel comprises a reel, wherein the preprinted surface comprises a reel strip mounted on the reel and comprising a plurality of game symbols, and wherein the game type associated with the received identifier corresponds to a first slot game type and the game type associated with the stored identifier corresponds to a different second slot game type.

18. The system of claim 17, wherein the processor receives a second identifier associated with a second preprinted surface comprising a second plurality of game symbols and the game type executable by the gaming device, each of the first and second preprinted surfaces corresponding to different reel strip identifiers, and successfully validates that the different reel strip identifiers correspond to the game type.

19. The system of claim 16, wherein the preprinted surface is mounted on a wheel and is divided into various segments, each segment representing a different outcome and wherein the game type associated with the received identifier corresponds to a first wheel game type and the game type associated with the stored identifier corresponds to a different second wheel game type.

20. The system of claim 16, wherein the processor enables the gaming device after the processor has confirmed that a state of the gaming device is idle for at least a predetermined period of time and that a selected game symbol of the plurality of game symbols is located in a predetermined position on the rotatable wheel.
